(19) United States
(12) Patent Application Publication
(10) Pub. No.: US 2015/0121386 A1
(43) Pub. Date: Apr. 30, 2015

(54) INDICATING STATUS, DUE DATE, AND URGENCY FOR A LISTED TASK BY A TASK TRACKING CONTROL

(71) Applicants: Tina Marseille, Heidelberg (DE); Martin Schrepp, Hockenheim (DE); Karin Bornheimer, Bensheim (DE); Anja Wipfler, Karlsruhe (DE)

(72) Inventors: Tina Marseille, Heidelberg (DE); Martin Schrepp, Hockenheim (DE); Karin Bornheimer, Bensheim (DE); Anja Wipfler, Karlsruhe (DE)

(73) Assignee: SAP AG, Walldorf (DE)

(21) Appl. No.: 14/063,582

(22) Filed: Oct. 25, 2013

(51) Int. Cl. G06F 9/48

(52) U.S. Cl. CPC G06F 9/4881
USPC 718/103

(57) ABSTRACT

Disclosed herein are representative embodiments of tools and techniques for displaying one or more task tracking controls to indicate respective progress statuses, urgency stages, and due dates for respective of one or more listed tasks of a procedure. According to one exemplary technique, a task list is received by a software. The task list including a listed task. In addition, a determination is made that the listed task is in an incomplete status. Also, an urgency stage is determined for the listed task. The listed task is associated with a due date for the listed task. Based on the determination that the listed task is in an incomplete status, a task tracking control is output for display. The task tracking control indicating the incomplete status of the listed task includes a visual indication of the due date and a visual indication of the urgency stage for the listed task.

### BACKGROUND

As business procedures become more complex, tools and techniques for monitoring the progress of procedures have grown. Some traditional systems use software with graphical user interfaces to monitor the progress of procedures. Although traditional systems have provided software with graphical user interfaces to monitor procedures progress, these traditional technologies are limited.

### SUMMARY

This disclosure presents various exemplary embodiments of tools and techniques for providing one or more task tracking controls to indicate respective progress statuses, urgency stages, and due dates for one or more listed tasks of a procedure. According to one exemplary technique, a task list is received by a software. The task list includes a listed task. In addition, a determination is made that the listed task is in an incomplete status. Also, an urgency stage is determined for the listed task. The listed task is associated with a due date for the listed task. Based on the determination that the listed task is in an incomplete status, a task tracking control is output for display. The task tracking control indicating the incomplete status of the listed task includes a visual indication of the due date and a visual indication of the urgency stage for the listed task.

According to an exemplary tool, a task list, for a procedure, is received by a software. The task list includes a listed task. Additionally, a determination is made that the listed task is in an incomplete status. Also, an urgency stage is determined for the listed task. The listed task is associated with a due date for the listed task. Based on the determination that the listed task is in an incomplete status, a task tracking control is displayed. The task tracking control indicating the incomplete status of the listed task includes a visual indication of the due date and a visual indication of the urgency stage for the listed task. After the listed task is completed, the displayed task tracking control can visually indicate that the listed task is in a completed status.

This summary is provided to introduce a selection of concepts in a simplified form that are further described below. This summary is not intended to identify key features or essential features of the claimed subject matter, nor is it intended to be used to limit the scope of the claimed subject matter. The foregoing and other objects, features, and advantages of the described technologies will become more apparent from the following detailed description, which proceeds with reference to the accompanying figures.

### BRIEF DESCRIPTION OF THE DRAWINGS

FIG. 1 is a schematic diagram of an exemplary computing system that outputs, for display, a task tracking control indicating an incomplete status of a listed task.

FIG. 2 is a flow diagram of an exemplary method for outputting a task tracking control indicating the incomplete status of a listed task.

FIG. 3A is a diagram of an exemplary displayed task tracking control indicating an incomplete status for a listed task that is in an open stage.

FIG. 3B is a diagram of an exemplary displayed task tracking control indicating an incomplete status for a listed task that is in a nearing due-date stage.

FIG. 3C is a diagram of an exemplary displayed task tracking control indicating an incomplete status for a listed task that is in a past due-date stage.

FIG. 3D is a diagram of an exemplary task tracking control indicating a completed status of a listed task.

FIG. 4 is a flow diagram of an exemplary method for determining an urgency stage for a listed task.

FIG. 5 is a diagram that illustrates an exemplary task tracking control transitioning from indicating an incomplete status for a listed task to indicating a completed status of the listed task.

FIG. 6 is a flow diagram of an exemplary method for displaying a task tracking control indicating an incomplete status of a listed task and then indicating a completed status of the listed task.

FIG. 7 is a diagram of an exemplary display displaying an exemplary software which includes exemplary task tracking controls for listed tasks.

FIG. 8 is schematic diagram illustrating a generalized example of a suitable computing environment for at least some of the disclosed embodiments.

### DETAILED DESCRIPTION

### Exemplary System for Outputting a Task Tracking Control Indicating an Incomplete Status of a Listed Task

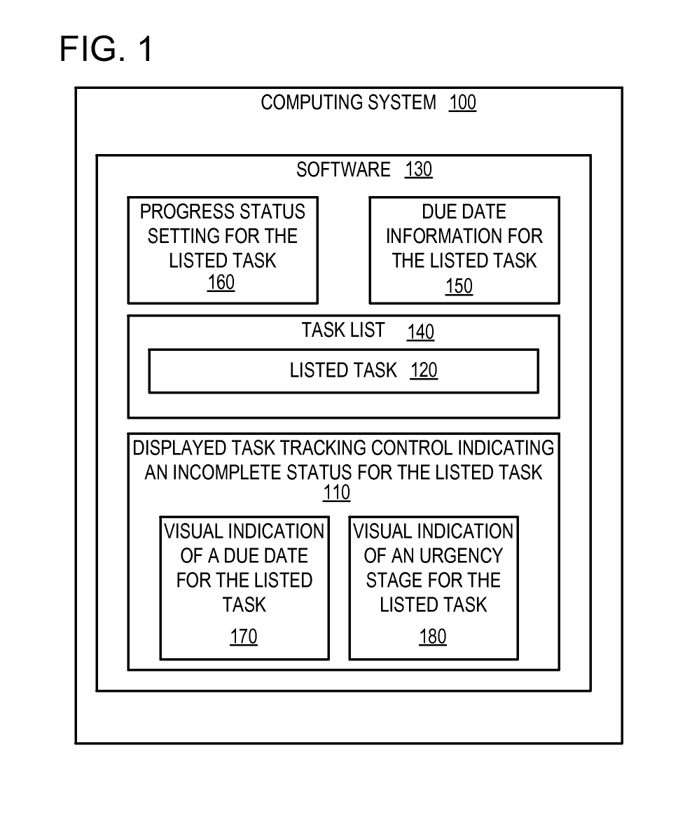

FIG. 1 is a schematic diagram of an exemplary computing system 100 that outputs, for display, a task tracking control 110 indicating an incomplete status of a listed task 120.

In FIG. 1, a software 130 includes a task list 140 for tracking one or more tasks for accomplishing a procedure. The task list 140 lists one or more tasks such as listed task 120. The listed task 120 can be associated with information used to track the progress of accomplishing and/or completing the listed task 120. For example, the listed task 120 is associated with a due date that is included in the due date information 150 for the listed task 120. The listed task 120 can be associated with and/or have a progress status such as an incomplete or completed status. For example, the listed task 120 can be determined to have an incomplete status by evaluating a progress status setting 160. The listed task 120 can be associated with an urgency stage determined based in part on the due date for the listed task 120. For example, an urgency stage can indicate an urgency for completing and/or accomplishing the listed task. In some implementations, an urgency stage can be one of an open stage, a nearing due-date stage, a past due-date stage or other like urgency stage. The listed task 120 is associated with the task tracking control 110.

The task tracking control 110 can be output for display. The task tracking control 110 can be displayed dynamically based at least in part on one or more information associated with the listed task 120. For example, information associated with the task tracking control can include the due date 150, an amount of time remaining until the due date, an amount of time elapsed since the due date, a threshold date, a current date or other information. In some implementations, the task tracking control can be a single display element that occupies an area of the display relative to an associated listed task. For example, using an area of the display a distance from the associated listed task 120, the task tracking control 110 can be displayed to visually indicate information, to a viewer, about the listed task 120. The task tracking control 110 can be displayed at a location in a display based on the location of the listed task 120.

The task tracking control 110 can indicate the determined incomplete status at least in part by including a visual indication of the due date 170 for the listed task and a visual indication of the urgency stage 180 for the listed task.

In some implementations, the appearance of the visual indication of the urgency stage can be displayed dynamically based on information associated with the listed task. For example, the visual indication of the urgency stage for the listed task 170 can be displayed using at least one color selected based on the determined urgency stage of the listed task. The selected at least one color can be a visual signal of the urgency stage for the listed task and can signal the urgency for accomplishing and/or completing the listed task. In some implementations, the visual indication of the urgency stage for the listed task 170 can be displayed based at least in part on a an amount of time between a current date and the due date. For example, the size and/or length of a signal portion can be displayed based on the amount of time between a current date and the due date for the listed task.

In some implementations, one or more task tracking controls can visually indicate to a user a progress status, an urgency stage, and a due date for respective listed tasks of the last list 140. For example, a user of the software can view the task tracking controls to receive the visually indicated information about its associated listed task. In some implementations, information visually indicated by the task tracking controls can be used by a viewer to prioritize and/or monitor the performance and/or completion of one or more listed tasks listed in task list 140 for the procedure.

### Exemplary Method for Outputting a Task Tracking Control Indicating an Incomplete Status of a Listed Task

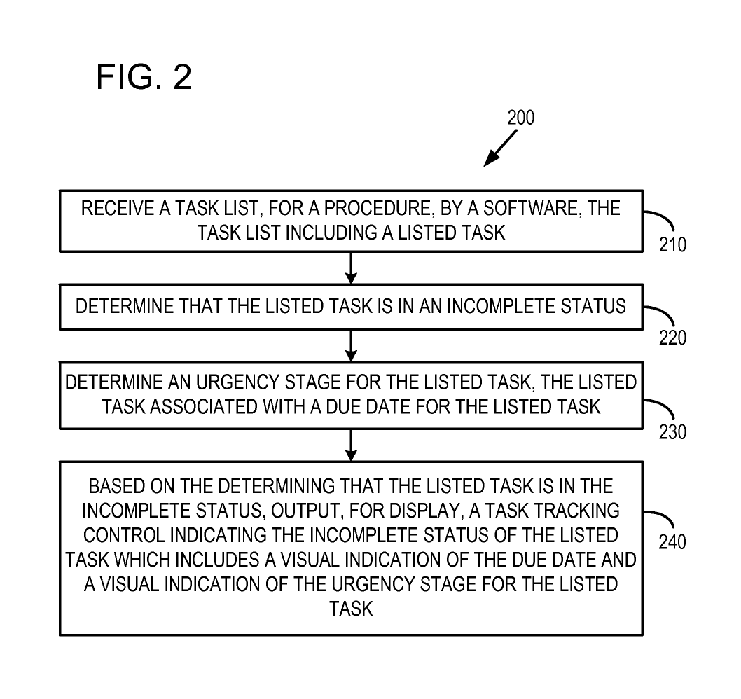

FIG. 2 is a flow diagram of an exemplary method 200 for outputting a task tracking control indicating the incomplete status of a listed task. In FIG. 2, at 210, a task list, for a procedure, is received by a software. The task list includes at least one listed task.

In some implementations, a software, such as a financial software, business software, or other software, can be capable of receiving a task list which lists one or more tasks to be performed to accomplish a procedure such as a business procedure, accounting procedure or other procedure. For example, a user of a software can enter a list of one or more tasks that can be done to accomplish a procedure such as a financial closing of a period of time such as a month, quarter, or other period. In some implementations, a procedure can include one or more tasks that can be performed to accomplish the procedure. In some implementations, the one or more tasks to be performed to accomplish a procedure can be listed as information to produce a task list. For example, a user of the software can list, as entries in the software, one or more tasks that are to be done to accomplish a procedure. In some implementations, the software has additional functionality such as functionality to perform and/or aid in the performance of one or more of the listed tasks.

In some implementations, a task listed in a task list can be a listed task to be performed as part of a procedure. For example, using the example of the financial closing procedure for accounting and/or other purposes, a financial software can include a listed task for running reports, discovering unpaid bills, or other job or function to be performed for the financial closing procedure.

In some implementations, a listed task can be a task that can be done manually, mechanically, electronically, automatically, or a combination thereof. In some implementations, the listed tasks for the procedure can have an order in which the listed tasks are scheduled to be performed. For example, one or more of the tasks can be scheduled to be performed by a due date before or after one or more other listed tasks are scheduled to be performed. In some implementations, one or more of the listed tasks can depend on the performance of one or more other listed tasks. In some implementations, one or more of the listed tasks do not depend on the performance of one or more other listed tasks.

In some implementations, a listed task can be associated with information such as one or more of a name or other identifier, a description of the listed task, information about a due date for the listed task, a threshold date for the listed task, a progress status, an urgency stage or other information about the listed task. In some implementations, a listed task can be output for display and/or displayed using the information about the listed task.

At 220, a determination is made that the listed task is in an incomplete status. For example, a progress status setting associated with the listed task can be evaluated to determine a progress status for the listed task. In some implementations, a progress status can relate to the amount of work that has been done for a listed task. For example, a progress status for the listed task can indicate that the listed task is incomplete or that the listed task has been completed. For example, if the listed task has been started and is in progress such that it is not yet completed the progress status setting for and/or associated with the listed task can be set to indicate that the listed task is in an incomplete status. If the listed task has been completed, the progress status setting for and/or associated with the listed task can be set to indicate that the listed task is in a completed status.

The progress status setting can be information associated with the listed task. For example, the progress status setting can be information associated with the listed task that is maintained by and/or accessible by the software that includes the listed task. In some implementations, a progress status setting can be set manually and/or automatically to indicate that the task has been completed. For example, using the example of a listed task for running a report for a financial closing procedure, after the running of the report has been completed using the software, the progress status setting for the listed task of the software can be automatically updated to indicate that the listed task is in a completed status as the listed status has been completed.

At 230, an urgency stage is determined for the listed task. The listed task can be associated with a due date for the listed task. For example, an urgency stage can be based on the amount of time between the current date and the due date for the listed task.

In some implementations, due date information indicating a due date by which the listed task is scheduled to be completed can be entered and/or associated with the listed task in setting a due date for the listed task. For example, a software that includes the listed task can have functionality to receive information to set a date and/or time as the due date for the listed task to associate the due date with the listed task. In some implementations, a due date for the listed task can be a time by which the listed task is scheduled to be performed and/or completed. In some implementations, the listed task can be performed and/or completed before the due date, at the due date, or after the due date.

In some implementations, the current date such as a date and/or time can be automatically determined and compared to the due date for the listed task indicated by the due date information associated with the listed task. In some implementations, based on the comparison of the current date with the due date, the current date can be determined to be after the due date. If the current date is determined to be after the due date, then the urgency stage for the listed task can be determined to be a past due-date stage. In some implementations, a past due date stage can be associated with an urgency (e.g., a high urgency or other urgency) for performing and/or completing the listed task as the due date for the listed task has passed and the listed task has not been completed. In some implementations, an urgency of a listed task can relate to the due date set for and/or associated with the listed task.

In some implementations, based on the comparison of the current date with the due date, the current date can be determined to be at or before the due date for the listed task. In some implementations, based on the current date being determined to be before or at the the due date, the current date can be compared to a threshold date for the listed task to determine if the current date is before, at, or after the threshold date. If the current date is determined to be before the threshold date, the urgency stage for the listed task can be an open stage. In some implementations, an open stage can be associated with an urgency (e.g. low urgency or other urgency) for performing and/or completing the listed task, as an open stage can indicate that there is more time to perform and/or complete the listed task before its associated due date. In some implementations, a listed task in an open stage can be started and in progress and/or not yet completed.

If the current date is determined to be at or after the threshold date, the urgency stage for the listed task can be a nearing due-date stage. In some implementations, a nearing due-date stage can be associated with an urgency (e.g. high urgency or other urgency) for performing and/or completing the listed task, as a nearing due-date stage can indicate that there is limited and/or a short amount of time to perform and/or complete the listed task before its associated due date. In some implementations, a listed task in a nearing due-date stage can be in progress and/or uncompleted and the current date is after the threshold date but at or before the due date indicating that due date for the listed task is near in time.

In some implementations, a threshold date for a listed task can be a predetermined date (e.g., a calendar date and/or time or other date) set for the listed task as threshold date information that is associated with the listed task. The threshold date information can be maintained and/or accessible by the software that includes the listed task. In some implementations, the threshold date can be set based on a percentage of the time that is available to complete the listed task. For example, if an allowed time for completing the listed task is the amount of time between a first date and a due date for the listed task, the threshold date can be set at a date that is a percentage of the allowed time before the due date. In some implementations, the threshold date can be set at a date that is near to the due date for the listed task after which the time to perform and/or complete the listed task before the due date is limited. For example, for a procedure that is scheduled to be a 3 day procedure, a threshold date for a listed task of the procedure can be set at one day before the due date for the listed task. In other implementations, the threshold date for the listed task can be set at one day before the due date or set at other dates.

With reference to FIG. 2 at 240, based on the determination that the listed task is in the incomplete status, a task tracking control indicating the incomplete status of the listed task is output for display. The task tracking control indicating the incomplete status, that is output, includes a visual indication of the due date for the listed task and a visual indication of the urgency stage for the listed task. In some implementations, a task tracking control can be provided by the software for outputting for display and/or provided by a display as displayed.

In some implementations, a task tracking control is displayed dynamically based at least in part on information associated with the listed task which is associated with the task tracking control. For example, an appearance of a task tracking control as displayed can be based at least in part on one or more of a progress status, an urgency stage, or a due date for a listed task associated with the task tracking control. In some implementations, the task tracking control includes a single display element that includes one or more or more visual attributes and/or portions such as one or more of a visual indication of a due date, a visual indication of an urgency stage, a visual indication that an associated listed task has been completed or the like.

In some implementations, the visual indication of the due date for the listed task can display at least some of the due date information for the listed task. For example, if the due date for a listed task is set as Dec. 3, 2014 at 5:00 PM, the visual indication can display one or more of the month, the day, the year, the hour, the minutes, or other time information for the due date. In some implementations, a portion of the due date can be displayed such as a portion of the calendar date such as one or more of an indicated day, month, or year. In some implementations, a time can be displayed such as one or more of an hour, minutes, or seconds. In some implementations, the visual indication of the due date is displayed with information that represents the due date information such as at least one abbreviation and/or at least one numerical symbol.

In some implementations, the visual indication of the due date is included in a due-date portion of the task tracking control. In some implementations, the displayed due date portion occupies an area of the displayed task tracking control that is surrounded by an urgency bar. In other implementations, the due date portion occupies an area of the displayed task tracking control that is not surrounded by an urgency bar.

In some implementations, an urgency bar includes the visual indication of the urgency stage. For example, the urgency bar can include a signal portion that visually indicates the urgency stage for the listed task. In some implementations, an urgency bar can be displayed as comprising a border of a shape.

In some implementations the urgency bar can be an annular shape for bordering rounded shapes. For example, the urgency bar can comprise a border of a rounded shape such as a circular shape, an oval shape or other like rounded shape. In some implementations, the urgency bar can comprise a border of a shape that includes straight edges such as a rectangle or other polygon. In some implementations, the urgency bar can surround the due-date portion or border the due date portion.

In some implementations, the signal portion of the urgency bar can be output for display and/or displayed as visually accented, using color or other accenting, to indicate the urgency stage for the listed task. The signal portion can be output for display and/or displayed with at least one color selected based on the determined urgency stage for the listed task. For example, the signal portion can be displayed with a first selected color (e.g., green or other color) when the listed task is in an open stage, a second selected color (e.g., orange or other color) when the listed task is in a nearing due-date stage, and a third color (e.g., red or other color) when the listed task is in a past due-date stage. In some implementations, the respective first, second, and third selected colors selected for the urgency stages can be different colors to distinctly indicate the respective different urgency stages.

In some implementations, the signal portion is output for display and/or displayed as having a size based on an amount of time between a due date for the listed task and a current date. For example, before the due date in an open or nearing due-date stage, as the current date becomes closer to the due date for the listed task, the signal portion becomes smaller in size. In some implementations, after the due date in a past due-date stage, as the current date becomes farther away from the due date for the listed task, the signal portion becomes larger in size. In some implementations for a uncompleted listed task, as the size of the signal portion dynamically varies with time, the signal portion can be a visual indication of the amount of time available to complete a listed task before a due date, or the amount of time that has passed after a due date. In some implementations, to change the size of the signal portion, at least one dimension (e.g., a length, a width or other like dimension) of the displayed signal portion can change based at least in part on the amount of time between the current date and the due date for the listed task.

In some implementations, the urgency bar can also include a de-emphasized portion. The de-emphasized portion can be output and/or displayed as visually de-emphasized using one or more colors. For example, the de-emphasized portion can be grayed out and/or otherwise de-emphasized using color. In some implementations, the appearance of the de-emphasized portion of the urgency bar is visually contrasted by the appearance of the accented signal portion of the urgency bar.

In some implementations, the de-emphasized portion is output for display and/or displayed as having a size based on the size of the signal portion. For example, before the due date, as the current date becomes closer to the due date for the listed task, the de-emphasized portion becomes larger in size. In some implementations, the de-emphasized portion comprises the portion of the urgency bar that is not the signal portion. In some implementations, the signal portion connects to the de-emphasized portion. For example, when the urgency bar borders a circle, the de-emphasized portion connects to the signal portion at a first end and a second end to comprise the completed border. In some implementations, an end of the signal portion can be a visual marker of the due date. For example, before the due date, the signal portion can become shorter toward the end that visually marks the due date. After the due date the signal portion can become longer away from the end that visually marks the due date.

In some implementations, as time progresses, the portions of the urgency bar can dynamically change in size. For example, as the signal portion becomes shorter in length, the de-emphasized portion can become longer in length in an amount based on the decrease in length of the signal portion. In some implementations, as the signal portion becomes longer in length, the de-emphasized portion can become shorter in length in an amount based on the decrease in length of the signal portion. In some implementations, before the due date, the de-emphasized portion can provide a visual indication of an amount of time that has passed between the current date and a date set as a creation date for the listed task. For example, the creation date can be set or can be the date the listed task was entered and/or received by the software that includes the listed task. In some implementations, at least one dimension (e.g., a length, a width or other like dimension) of the displayed de-emphasized portion of the urgency bar can change based at least in part on the size of the signal portion.

In some implementations, the visual indication of an urgency stage can be displayed other than using an urgency bar. For example, in some implementations, a task tracking control can be displayed as an image of a glass with a visual indication of the urgency stage for an associated listed task. For example the visual indication of the urgency stage can be accented contents (e.g., an image of liquid or other contents) of the displayed glass that are accented to signal (e.g., visually indicate) the urgency stage of an associated listed task. The task tracking control including an image of a glass can be displayed dynamically based on a progress status, urgency stage, or due date for the associated listed task. For example, the task tracking control including the glass image can be displayed differently when the listed task is completed than when the listed task is uncompleted. In some implementations, for a tracking control including a glass image, the visual indication of the urgency stage can become fuller or emptier with the displayed contents based at least in part on one or more of the urgency stage and the time between the due date for the listed task and a current date.

In some implementations, a progress status setting for the listed task can be evaluated to determine that the listed task is in a completed status. In some implementations, the displayed task tracking control can visually indicate a completed status for the listed task. For example, the task tracking control can be displayed using an image (e.g., a smiling face image, a check mark image, or other image) to indicate that the listed task is in a completed status and completed. In some implementations, after the listed task is completed, the task tracking control can appear as including the image visually indicating the completed status. In some implementations, the image visually indicating the completed status of the listed task can replace the appearance of the task tracking control that indicated the incomplete status of the listed task.

### Exemplary Displayed Task Tracking Control for a Listed Task

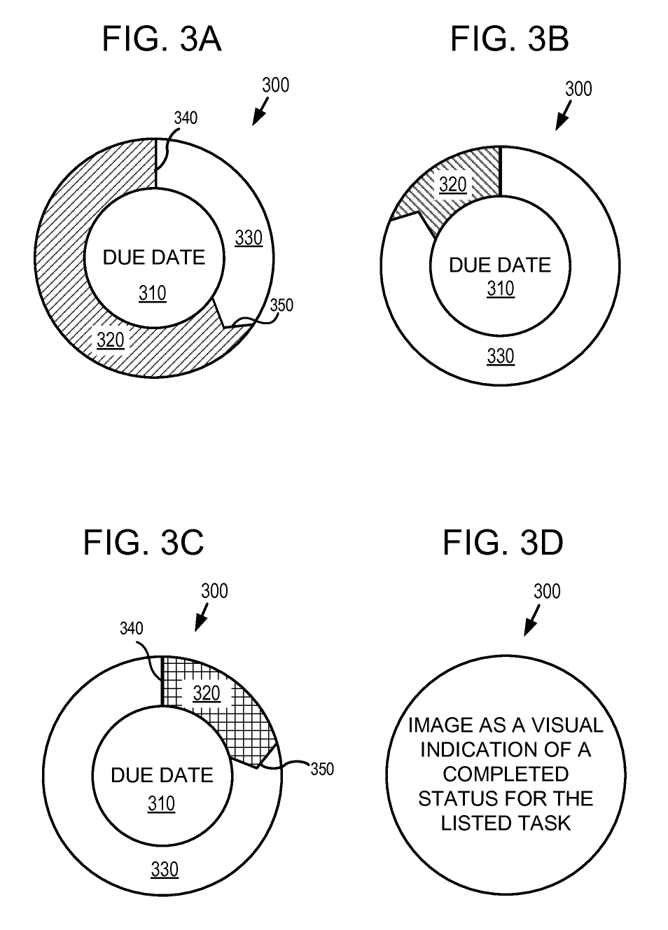

FIGS. 3A-3D are diagrams of an exemplary task tracking control 300 displayed at various times. As shown in FIG. 3A, the exemplary displayed task tracking control 300 indicates an incomplete status for an associated listed task in an open stage at a determined current time. In FIG. 3A, the displayed task tracking control 300 includes a due-date portion 310 that comprises a visual indication of the due date for the listed task. In FIG. 3A, the displayed task tracking control 300 includes a circular urgency bar that includes a signal portion 320 and a de-emphasized portion 330. In some implementations, as illustrated in FIG. 3A, the task tracking control is displayed as oriented similarly to a clock and visually indicates the passage of time. For example, in FIG. 3A, the signal portion end 340 is displayed at the 12 o'clock position of the task tracking control. In other implementations, the signal portion end 340 can be displayed at other positions within the task tracking control. In FIG. 3A, the urgency stage for the listed task associated with the task tracking control 300 is an open stage. For the example shown in FIG. 3A, the determined current time is before the threshold date and the due date associated with the listed task. In FIG. 3A, the signal portion 320, of the urgency bar, is displayed as visually accented using at least one color selected based on the urgency stage of the listed task being the open stage. The visual accenting of the signal portion 320, in FIG. 3A, is represented by shading lines. In FIG. 3A, the signal portion 320 is located in the urgency bar and visually accented before the 12 o'clock position of the task tracking control 300. In FIG. 3A, the size of the signal portion 320 is based on the amount of time between the determined current date and the due date for the associated listed task. For example, the length of the signal portion 320 within the urgency bar is based on the amount of time that is remaining from the determined current date until the due date for the listed task.

In FIG. 3A, the size of the de-emphasized portion 330 is based on the length of the signal portion 320. In some implementations, as the signal portion 320 becomes smaller in size and/or shorter in length, the de-emphasized portion 330 becomes larger in size and/or longer in length. In some implementations, the de-emphasized portion 330 comprises the remainder of the urgency bar left by the signal portion 320. For example, the urgency bar can border a shape and the signal portion can connect with the de-emphasized portion, of the urgency bar, to border the shape and/or surround the due date portion, of the task tracking control, that includes the visual indication of the due date. In some implementations, the length of the signal portion 320 can be a visual indicator, to a viewer, of how much time there is until a due date or how much time has passed after a due date.

After the task tracking control 300 is displayed, at a first time, as illustrated in FIG. 3A, the task tracking control can transition to be displayed, at a second time, as illustrated in FIG. 3B. In FIG. 3B, the exemplary displayed task tracking control 300 indicates the incomplete status for the listed task that is in an urgency stage that is a nearing due-date stage at the second time. For the example shown in FIG. 3B, the second time is the current date which is determined to be after the threshold date and before the due date associated with the listed task. In FIG. 3B, the displayed task tracking control 300 includes the due-date portion 310 and the urgency bar that includes the signal portion 320 and the de-emphasized portion 330. At the second time, as shown in FIG. 3B, the signal portion 320, is displayed as visually accented using at least one color selected based on the urgency stage of the listed task being the nearing due-date stage. The signal portion 320 signaling the nearing due-date stage, as illustrated in FIG. 3B, is accented using a color that is different than the color used for accenting the signal portion 320 as illustrated in FIG. 3A. The visual accenting of the signal portion 320, as illustrated in FIG. 3B, is represented by shading lines. In FIG. 3B, the signal portion is located as included in the urgency bar and visually accented before the 12 o'clock position of the task tracking control.

In FIG. 3B, the size of the signal portion 320 is based on the amount of time between the determined current date and the due date for the listed task. For example, the amount of the area and/or space of the urgency bar that includes the signal portion can be based on the amount of time that is remaining from the second time until the due date for the listed task. As time has passed between the first time of the example illustrated in FIG. 3A and the second time of the example illustrated in FIG. 3B, the displayed signal portion 320 as illustrated in FIG. 3B is shorter in length than the displayed signal portion 320 as illustrated in FIG. 3A. Also, as time has passed between the first time of the example illustrated in FIG. 3A and the second time of the example illustrated in FIG. 3B, the displayed de-emphasized portion 330 as illustrated in FIG. 3B is longer in length than the displayed de-emphasized portion 330 as illustrated in FIG. 3A.

After the task tracking control 300 is displayed, as illustrated in FIG. 3B, at the second time, the task tracking control can transition to be displayed, at a third time after the due date, as illustrated in FIG. 3C. In FIG. 3C, the exemplary displayed task tracking control 300 indicates the incomplete status for the listed task that is in an urgency stage that is a past due-date stage. For the example shown in FIG. 3C, the third time is the current date which is determined to be after the due date associated with the listed task.

In FIG. 3C, the displayed task tracking control 300 includes the due-date portion 310 and the urgency bar that includes the signal portion 320 and the de-emphasized portion 330. At the third time which is past the due date, as illustrated in FIG. 3C, the signal portion 320, is displayed as visually accented using at least one color selected based on the urgency stage of the listed task being the past due-date stage. The signal portion 320 signaling the past due-date stage, as illustrated in FIG. 3C is accented using a color that is different than the color used for accenting the signal portion 320 as illustrated in FIG. 3A and the color used for accenting the signal portion 320 as illustrated in FIG. 3B. The visual accenting of the signal portion 320, as illustrated in FIG. 3C, is represented by the hatching shown. In FIG. 3C, the signal portion is located in the urgency bar and visually accented after the 12 o'clock position of the task tracking control.

In FIG. 3C, the size of the signal portion 320 is based at least in part on the amount of time between the determined current date and the due date for the listed task. For example, the amount of the area and/or space of the urgency bar that includes the signal portion is based on the amount of time that has passed after the due date for the listed task up to the current date for the example shown in FIG. 3C. In the example illustrated in FIG. 3C, the length of the signal portion 320 of the urgency bar is based in part on the amount of time that has passed between the due date for the listed task and the current time for the example illustrated in FIG. 3C. In some implementations, when a listed task is in a past due-date stage, the signal portion of the urgency bar can increase in size and/or length up to a predetermined or determined size and/or length. As illustrated in FIG. 3C, the displayed de-emphasized portion 330 can occupy and/or comprise the section of the urgency bar that remains from the signal portion 320.

In some implementations, the shape of the signal portion can visually indicate if the signal portion is becoming larger in size (e.g., longer) or smaller (e.g., shorter) in size as time progresses. For example, in FIG. 3C, the signal portion end 350 is opposite of the signal portion end 340. Signal portion end 340 can be a visual marker of the due date for the associated listed task. In FIG. 3C, the pointed shape of the signal portion end 350 which points clockwise away from the signal portion end 340 visually indicates that, as time progresses, the signal portion is lengthening away from the signal portion end 340 which visually marks the due date for the listed task. As illustrated in FIG. 3A, the pointed shape of the signal portion end 350 which points clockwise toward the signal portion end 340 visually indicates that, as time progresses, the signal portion is shortening toward the signal portion end 340 which visually marks the due date for the listed task.

In FIG. 3D, the exemplary displayed task tracking control 300 indicates that the listed task has a completed status. After the listed task is completed and a progress status setting for the listed task is updated to indicate that the listed task is completed, the task tracking control 300 transitions to be displayed as illustrated in FIG. 3D. In FIG. 3D, the task tracking control is displayed as an image that visually signifies that the listed task has been completed and is in a completed status. As illustrated in FIG. 3D, the task tracking control 300 is displayed as indicating the completed status of the listed task does not include a visual indication of the due date (e.g., an urgency bar or the like) or a visual indication of the due date (e.g., a due date portion or the like).

### Exemplary Method for Determining an Urgency Stage of a Listed Task

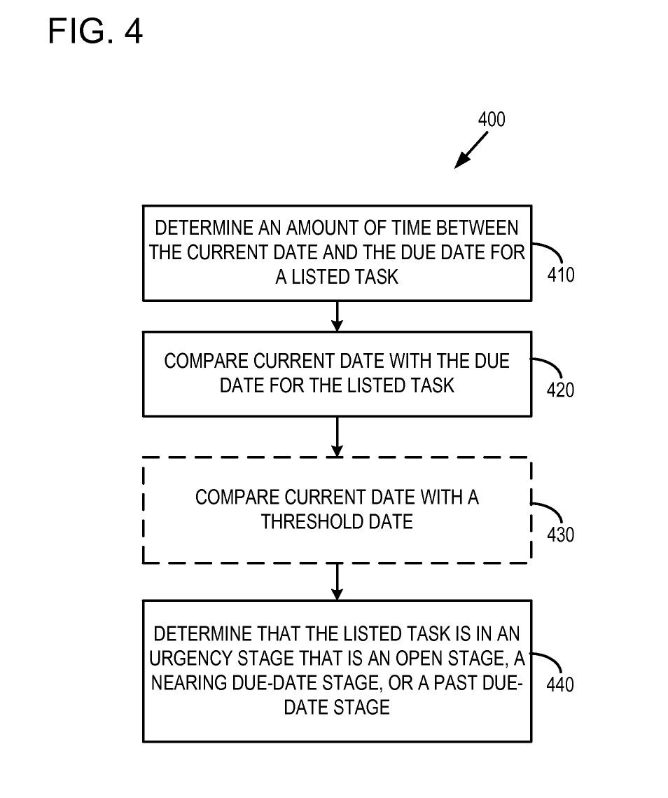

FIG. 4 is a flow diagram of an exemplary method 400 for determining an urgency stage for a listed task. The exemplary method 400 can be used with any of the described methods and/or systems described herein such as with exemplary method 200 or exemplary method 600. In FIG. 4, an amount of time between the current date and the due date for a listed task is determined at 410.

At 420, the current date is compared to the due date for the listed task. Based on the comparison of the current date to the due date, a determination can be made that the current date is before the due date, at the due date, or after the due date for the listed task.

If a determination is made that the current date is before the due date, the current date is compared to a threshold date as shown at block 430 of FIG. 4. Based on the comparison of the current date to the threshold date for the listed task, a determination can be made that the current date is before the threshold date, at the threshold date, or after the threshold date. In FIG. 4 block 430 is shown with dashed lines representing that the block 430 can be optional. For example, if a determination is made that the current date is after the due date based on the comparison as shown at 420, the comparing of the current date to a threshold date as shown at block 430 can be skipped.

At 440, a determination is made that the listed task is in an urgency stage such as one of an open stage, a nearing due-date stage, a past due-date stage, or other urgency stage.

### Exemplary Task Tracking Control Changing from Indicating an Incomplete Status to Indicating a Completed Status for a Listed Task

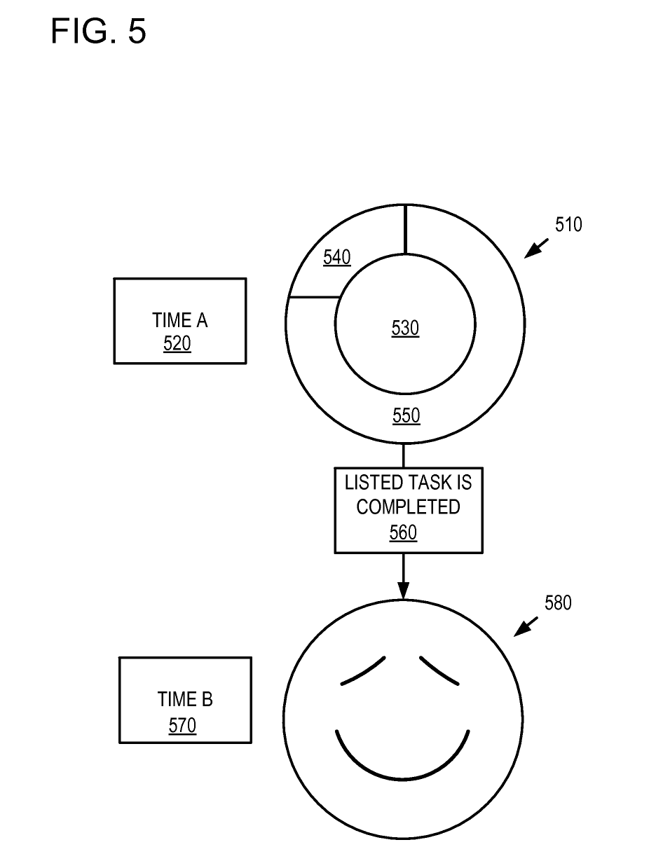

FIG. 5 is a diagram that illustrates an exemplary task tracking control transitioning from indicating an incomplete status of a listed task to indicating a completed status of a listed task. In FIG. 5, as illustrated at 510, the task tracking control is displayed to indicate an incomplete status for a listed task at a first time 520. As illustrated at 510, the task tracking control includes a visual indication of the due date 530 and a visual indication of the urgency stage that includes a signal portion 540 of an urgency bar and a de-emphasized portion 550 of an urgency bar.

As shown at 560, the listed task associated with the task tracking control is completed. As shown at 580, the displayed task tracking control is changed to indicate the listed task is in a completed status at a second time 570 after the listed task was completed. As illustrated at 580, the task tracking control is displayed using an image that visually indicates to a viewer that the listed task has been completed. In FIG. 5 at 580, the example task tracking control is displayed using an image of a smiling face, however in other implementations a different image can be used to indicate that the listed task is in a completed status. As shown at 580, the example tracking control indicating the completed status of the listed task is not displayed showing the due date for the listed task or an urgency bar.

### Exemplary Method for Displaying a Task Tracking Control Indicating an Incomplete Status and then Indicating a Completed Status of a Listed Task

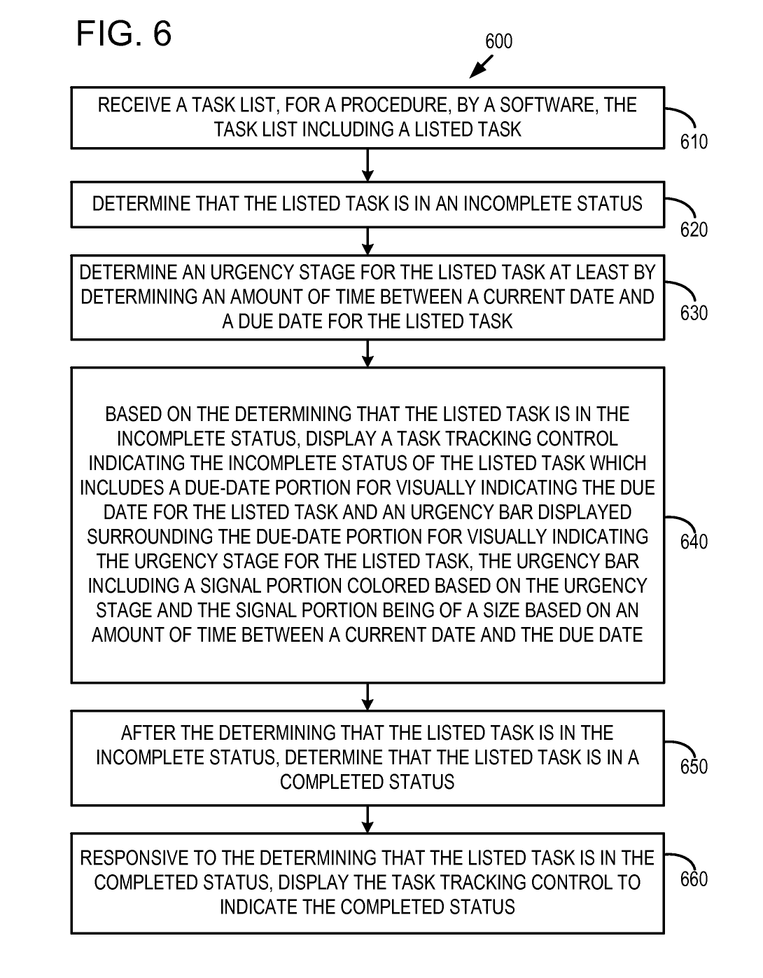

FIG. 6 is a flow diagram of an exemplary method 600 for displaying a task tracking control indicating an incomplete status of a listed task and then indicating a completed status of the listed task. In FIG. 6, at 610, a task list, for a procedure, is received by a software. The task list includes a listed task.

At 620, a determination is made that the listed task is in an incomplete status.

At 630, an urgency stage is determined for the listed task at least by determining an amount of time between a current date and a due date for the listed task.

At 640, based on the determination that the listed task is in the incomplete status, a task tracking control indicating the incomplete status of the listed task is displayed. The displayed task tracking control indicating the incomplete status includes a due-date portion for visually indicating the due date for the listed task and an urgency bar displayed surrounding the due-date portion for visually indicating the urgency stage for the listed task. The urgency bar includes a signal portion colored based at least in part on the urgency stage and the signal portion can be of a size based on an amount of time between a current date and the due date.

At 650, after the determining that the listed task is in the incomplete status, a determination is made that the listed task is in a completed status.

At 660, responsive to the determining that the listed task is in the completed status, the task tracking control is displayed to indicate the completed status of the listed task.

### Exemplary Displayed Software that Includes Task Tracking Controls for Listed Tasks

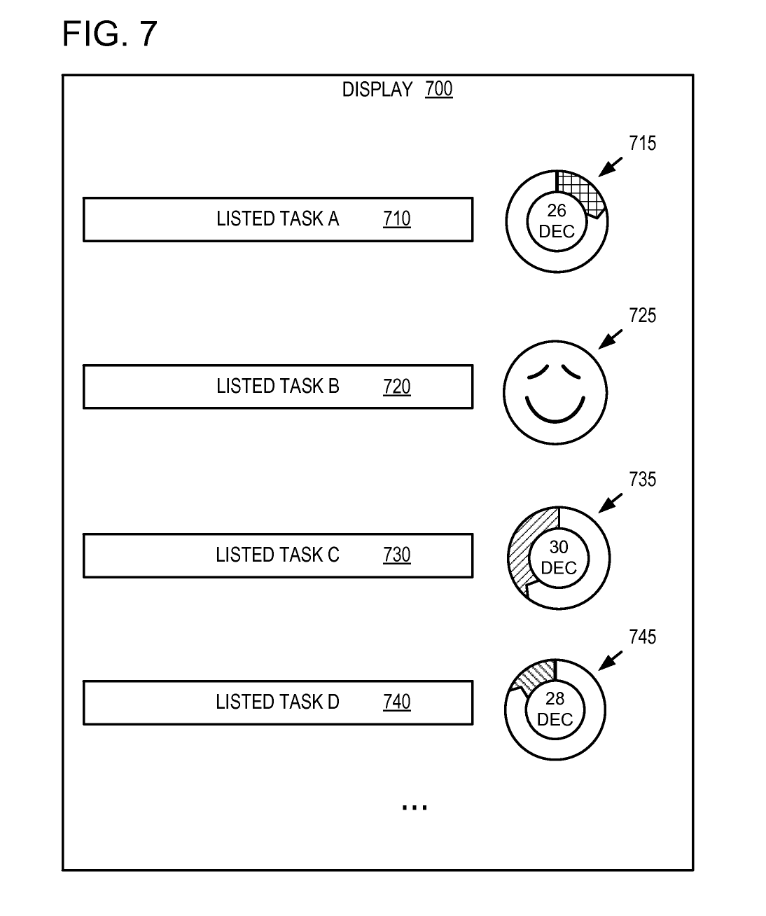

FIG. 7 is a diagram of an exemplary display 700 displaying an exemplary software which includes exemplary task tracking controls 715, 725, 735, and 745 for respective listed tasks 710, 720, 730, and 740. In FIG. 7, a task list for a procedure is displayed including the listed task 710, the listed task 720, the listed task 730, and the listed task 740.

A listed task such as listed task 710 can be associated with information that can be used to determine a progress status, an urgency status, and due date for the listed task. As shown in FIG. 7, listed task 710 is associated with the task tracking control 715. The task tracking control 715 is located in the display at an area relative to and/or based on the location of the listed task 710 in the display. The location of the task tracking control 715 in the display being relative to the listed task 710 can be a visual indication that the task tracking control 715 is associated with the listed task 710 and that the task tracking control 715 is displayed based on information associated with the listed task 710. The task tracking control 715 visually indicates that the listed task 710 has an incomplete status as the listed task 710 is incomplete. The task tracking control 715 visually indicates that the listed task 710 is in a past due-date stage at least using accenting of the signal portion which is represented with hatching. The listed task 710 is not completed and the due date for the listed task 710 has passed as the determined current date for the task tracking controls shown in FIG. 7 is December 27th. In FIG. 7, the task tracking control 715 visually indicates that the due date for the listed task 710 is December 26^{th} in a due date portion of the task tracking control 715.

The task tracking control 725 is associated with the listed task 720. The task tracking control 725 visually indicates that the listed task 720 is in a completed status and completed.

The task tracking control 735 is associated with the listed task 730. The task tracking control 735 visually indicates that the listed task 730 is in an incomplete status as the listed task 730 has not been completed. The urgency bar included in the task tracking control 735 visually indicates that the listed task 730 is in an open stage at least using accenting of the signal portion which is represented with shading lines. In FIG. 7, the task tracking control 735 visually indicates that the due date for the listed task 730 is December 30th in a due date portion of the task tracking control 735.

The task tracking control 745 is associated with the listed task 740. The task tracking control 745 visually indicates that the listed task 740 is in an incomplete status as the listed task 740 has not been completed. The urgency bar included in the task tracking control 745 visually indicates that the listed task 740 is in a nearing due-date stage at least using accenting of the signal portion which is represented with shading lines. In FIG. 7, the task tracking control 745 visually indicates the due date for the listed task 740 is December 28th in a due date portion of the task tracking control 745.

### Exemplary Computing Environment

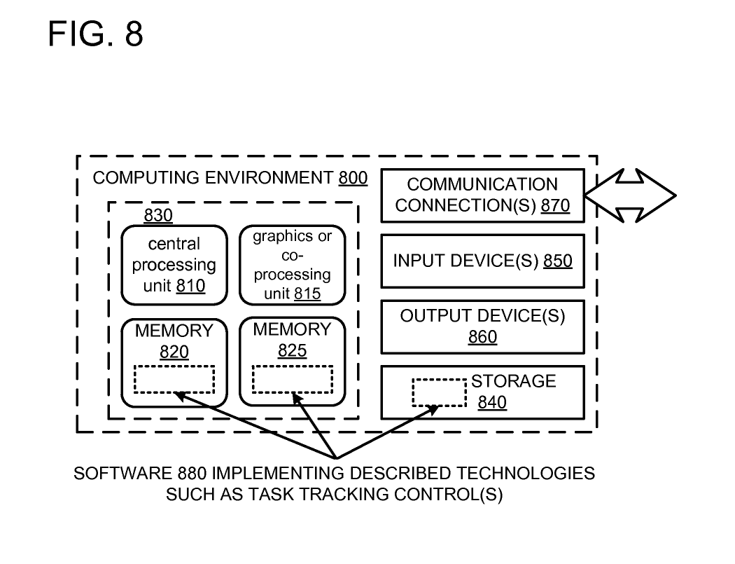

FIG. 8 depicts a generalized example of a suitable computing environment 800 in which the described innovations may be implemented. The computing environment 800 is not intended to suggest any limitation as to scope of use or functionality, as the innovations may be implemented in diverse general-purpose or special-purpose computing systems. For example, the computing environment 800 can be any of a variety of computing systems including one or more computing devices (e.g., desktop computer, laptop computer, server computer, tablet computer, media player, gaming system, mobile device, etc.)

With reference to FIG. 8, the computing environment 800 includes one or more processing units 810, 815 and memory 820, 825. In FIG. 8, this basic configuration 830 is included within a dashed line. The processing units 810, 815 execute computer-executable instructions. A processing unit can be a general-purpose central processing unit (CPU), processor in an application-specific integrated circuit (ASIC) or any other type of processor. In a multi-processing system, multiple processing units execute computer-executable instructions to increase processing power. For example, FIG. 8 shows a central processing unit 810 as well as a graphics processing unit or co-processing unit 815. The tangible memory 820, 825 may be volatile memory (e.g., registers, cache, RAM), non-volatile memory (e.g., ROM, EEPROM, flash memory, etc.), or some combination of the two, accessible by the processing unit(s). The memory 820, 825 stores software 880 implementing one or more technologies described herein, in the form of computer-executable instructions suitable for execution by the processing unit(s).

A computing system may have additional features. For example, the computing environment 800 includes storage 840, one or more input devices 850, one or more output devices 860, and one or more communication connections 870. An interconnection mechanism (not shown) such as a bus, controller, or network interconnects the components of the computing environment 800. Typically, operating system software (not shown) provides an operating environment for other software executing in the computing environment 800, and coordinates activities of the components of the computing environment 800.

The tangible storage 840 may be removable or non-removable, and includes magnetic disks, magnetic tapes or cassettes, CD-ROMs, DVDs, or any other medium which can be used to store information in a non-transitory way and which can be accessed within the computing environment 800. The storage 840 stores instructions for the software 880 implementing one or more technologies described herein such as for outputting and/or displaying one or more task tracking controls.

The input device(s) 850 may be a touch input device such as a keyboard, mouse, pen, or trackball, a voice input device, a scanning device, or another device that provides input to the computing environment 800. For video encoding, the input device(s) 850 may be a camera, video card, TV tuner card, or similar device that accepts video input in analog or digital form, or a CD-ROM or CD-RW that reads video samples into the computing environment 800. The output device(s) 860 may be a display, printer, speaker, CD-writer, or another device that provides output from the computing environment 800.

The communication connection(s) 870 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, or other carrier.

Although the operations of some of the disclosed methods are described in a particular, sequential order for convenient presentation, it should be understood that this manner of description encompasses rearrangement, unless a particular ordering is required by specific language set forth below. For example, operations described sequentially may in some cases be rearranged or performed concurrently. Moreover, for the sake of simplicity, the attached figures may not show the various ways in which the disclosed methods can be used in conjunction with other methods.

Any of the disclosed methods can be implemented as computer-executable instructions stored on one or more computer-readable storage media (e.g., one or more optical media discs, volatile memory components (such as DRAM or SRAM), or nonvolatile memory components (such as flash memory or hard drives)) and executed on a computer (e.g., any commercially available computer, including smart phones or other mobile devices that include computing hardware). The term computer-readable storage media does not include communication connections, such as signals and carrier waves. Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network (such as a cloud computing network), or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in C++, Java, Perl, JavaScript, Adobe Flash, or any other suitable programming language. Likewise, the disclosed technology is not limited to any particular computer or type of hardware. Certain details of suitable computers and hardware are well known and need not be set forth in detail in this disclosure.

It should also be well understood that any functionality described herein can be performed, at least in part, by one or more hardware logic components, instead of software. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, and infrared communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope of these claims.

We claim:

1. A method comprising:
receiving a task list by a software, the task list comprising a listed task;
determining that the listed task is in an incomplete status;
determining an urgency stage for the listed task, the listed task associated with a due date for the listed task; and
based in part on the determining that the listed task is in the incomplete status, outputting, for display, a task tracking control indicating the incomplete status of the listed task, the outputted task tracking control indicating the incomplete status comprising a visual indication of the due date and a visual indication of the urgency stage for the listed task.

2. The method of claim 1, wherein the listed task is a first listed task and the task tracking control is a first task tracking control and the method further comprising:
a second listed task;
outputting a second task tracking control indicating an incomplete status of the second listed task, the outputted second task tracking control indicating the incomplete status of the second listed task comprising a visual indication of an urgency stage for the second listed task, the urgency stage for the second listed task being different than the urgency stage for the first listed task;
determining that the second listed task is in a completed status; and
based in part on the determining that the second listed task is in the completed status, outputting the second task tracking control to indicate the completed status of the second listed task.

3. The method of claim 1, wherein the task tracking control is a single display element which occupies an area relative to the listed task.

4. The method of claim 1, wherein the determining the urgency stage for the listed task comprises determining an amount of time between a current date and the due date for the listed task.

5. The method of claim 1, wherein the visual indication of the urgency stage comprises a signal portion output for display using a color determined based on the urgency stage.

6. The method of claim 4, wherein a size of the signal portion is at least based on an amount of time between the current date and the due date for the listed task.

7. The method of claim 1, wherein the outputted task tracking control indicating the incomplete status comprises a due-date portion, the due-date portion comprising the visual indication of the due date for the listed task.

8. The method of claim 5, wherein the visual indication of the urgency stage comprises an urgency bar, the urgency bar comprising the signal portion connected to a de-emphasized portion; and
wherein the urgency bar is output, for display, as surrounding the due-date portion of the task tracking control.

9. The method of claim 1, wherein the determining the urgency stage of the listed task comprises comparing a current date to a threshold date.

10. The method of claim 1, further comprising determining that the listed task is in a completed status; and
based in part on the determining that the listed task is in the completed status, outputting, for display, the task tracking control to indicate the completed status.

11. The method of claim 1, further comprising determining that the urgency stage is in an open stage, a nearing due-date stage, or a past due-date stage.

12. A computing system comprising at least one processor and memory, the memory storing computer-executable instructions for causing the computing system to perform a method, the method comprising:
receiving a task list, for a procedure, by a software, the task list comprising a listed task;
determining that the listed task is in an incomplete status;
determining an urgency stage for the listed task, the listed task associated with a due date for the listed task; and
based in part on the determining the listed task is in the incomplete status, displaying a task tracking control indicating the incomplete status of the listed task, the displayed task tracking control indicating the incomplete status of the listed task comprising a visual indication of the due date and a visual indication of the urgency stage for the listed task.

13. The computing system of claim 12, further comprising wherein the determining the urgency stage for the listed task comprises:
determining an amount of time between a current date and the due date for the listed task; and
comparing the current date to a threshold date.

14. The computing system of claim 12, further comprising wherein the software is a financial software; and
wherein the determining that the listed task is in the incomplete status comprises evaluating a progress status setting, of the financial software, for the listed task.

15. The computing system of claim 12, further comprising wherein the displayed task tracking control indicating the incomplete status comprises a due-date portion, the due-date portion comprising the visual indication of the due date for the listed task.

16. The computing system of claim 15, further comprising wherein the visual indication of the urgency stage comprises a signal portion displayed using a color determined based on the urgency stage; and
wherein a size of the signal portion is at least based on an amount of time between the current date and the due date for the listed task.

17. The computing system of claim 16, wherein the visual indication of the urgency stage comprises a circular urgency bar, the circular urgency bar comprising:
the signal portion connecting to the de-emphasized portion; and
wherein the circular urgency bar is displayed as surrounding the due-date portion of the task tracking control.

18. The computing system of claim 12, further comprising determining that the listed task is in a completed status; and
based in part on the determining that the listed task is in the completed status, displaying the task tracking control to indicate the completed status at least by displaying the task tracking control as a predetermined image comprising a smiling face.

19. The computing system of claim 12, further wherein the the urgency stage is an open stage, a nearing due-date stage, or a past due-date stage.

20. One or more computer-readable media storing computer-executable instructions for causing a computing system to perform a method, the method comprising:
receiving a task list, for a procedure, by a financial software, the task list comprising a listed task;
determining that the listed task is in an incomplete status;
determining an urgency stage for the listed task at least by determining an amount of time between a current date and a due date for the listed task; and
based in part on the determining that the listed task is in the incomplete status, displaying a task tracking control indicating the incomplete status of the listed task, the displayed task tracking control indicating the incomplete status of the listed task comprising:
a due-date portion for visually indicating the due date for the listed task; and
an urgency bar displayed surrounding the due-date portion for visually indicating the urgency stage for the listed task, the urgency bar comprising a signal portion colored based on the urgency stage and the signal portion being of a size based on an amount of time between a current date and the due date; and
after the determining that the listed task is in the incomplete status, determining that the listed task is in a completed status; and
responsive to the determining that the listed task is in the completed status, displaying the task tracking control to indicate the completed status.
